(19) United States
(12) Patent Application Publication
(10) Pub. No.: US 2009/0291203 A1
(43) Pub. Date: Nov. 26, 2009

(54) SUBSTRATE TRAY AND FILM FORMING APPARATUS

(75) Inventors: Seiji Hagi, Tama-shi (JP); Seiji Hatayama, Hino-shi (JP); Kazutoshi Nishio, Higashiyamato-shi (JP)

Correspondence Address: FITZPATRICK CELLA HARPER & SCINTO, 1290 Avenue of the Americas, NEW YORK, NY, 10104-3800, US

(73) Assignee: CANON ANELVA CORPORATION, Kawasaki-shi, Kanagawa-ken (JP)

(21) Appl. No.: 12/307,782

(22) PCT Filed: Jul. 4, 2007
(86) PCT No.: PCT/JP2007/063391

§ 371 Date: Jan. 7, 2009

(30) Foreign Application Priority Data
Jul. 7, 2006 (JP) 2006-188522

(51) Int. Cl. B05D 5/12; B05C 13/02

(52) U.S. Cl. 427/126.3; 427/58; 118/504; 118/500

(57) ABSTRACT

A substrate tray which holds a substrate and is arranged to oppose a thin film material source is characterized by including a holding member which holds the substrate and is provided with an opening through which thin film material particles emitted from the thin film material source to be deposited on the substrate pass, a first mask which is arranged between the holding member and the substrate and shields the thin film material particles passing through the opening not to deposit on the substrate, to form a thin film having a predetermined shape on the substrate, and a second mask which is arranged between the holding member and the first mask and covers the first mask at least partly to shield the thin film material particles not to deposit on the first mask.

### TECHNICAL FIELD

The present invention relates to a substrate tray used in a film forming apparatus to hold a substrate and, more particularly, to a substrate tray used when forming a protection film for a plasma display panel, and a film forming apparatus comprising the substrate tray.

### BACKGROUND ART

Demands for a PDP (Plasma Display Panel) as well as a liquid crystal panel increase every year as a flat wall-hanging television. As the panel size increases and the panel performance is improved, studies have been made on a film forming apparatus and film forming method so as to improve the yield, throughput, and other productivity factors.

For example, a process of forming a MgO (magnesium oxide) protection film for a PDP employs a substrate tray 51 shown in FIGS. 4A and 4B to transport a substrate in the film forming apparatus. FIG. 4A is an exploded perspective view of the substrate tray 51, and FIG. 4B is a plan view showing a state in which a mask 54 and glass substrate 55 are placed on a holding member 52. The substrate tray 51 comprises the holding member 52 provided with an opening 52a having a predetermined shape, and the mask 54 which is provided with an opening 54a having the same shape as a predetermined pattern (e.g., a pattern that covers the peripheral portion of the glass substrate 55 so as to serve as an adhesion seal portion or wire deriving portion) to be formed on the glass substrate 55 and the end of which is supported on the holding member 52. The glass substrate 55 is supported by the holding member 52 through the mask 54 which is arranged in tight contact with the glass substrate 55.

The glass substrate 55 placed on the holding member 52 is transported into a deposition chamber of the film forming apparatus and arranged above a deposition material source to oppose it. In the deposition chamber, MgO thin film material particles scatter from a deposition material evaporating upon being heated by, for example, a plasma beam from a plasma gun, in the direction of an arrow shown in FIG. 4A. The MgO thin film material particles pass through the opening 54a of the mask 54 to deposit on the glass substrate 55, thus forming a thin film having the predetermined pattern.

An example of the background art described above includes, for example, patent reference 1 (Japanese Patent Laid-Open No. 2005-54244).

### DISCLOSURE OF INVENTION

### Problems that the Invention is to Solve

In the film forming apparatus described above, the film formed on the glass substrate 55 covers the mask 54 as well, and the mask 54 is exposed to heat radiation from the deposition material source during heating and deposition, the ring hearth that accommodates the deposition material source, and the like. Therefore, the following problems arise.

FIG. 5 is a view showing the state of the mask 54 on which a film has been formed using the substrate tray shown in FIGS. 4A and 4B, and the film formation state on the glass substrate 55. As shown in FIG. 5, when the film is attached to the mask 54, the mask 54 is hardened as its flexibility on the surface side decreases, and the stress of the attached film distorts (warps) the mask 54. The glass substrate 55 is exposed to heat radiation from the evaporation material source, the ring hearth that accommodates the evaporation material source, and the like, and is accordingly deflected. Therefore, the adhesion strength between the deflected glass substrate 55 and distorted mask 54 decreases to form a gap between them. If film formation continues in this state, the deposition material particles undesirably enter and are deposited on a region that should originally be masked. This makes masking incomplete. In a resultant protection film 56, an end face 57 is retreated inward the region that should originally be masked. Thus, the protection film 56 has a shape different from a desired pattern.

### Means of Solving the Problems

The present invention has been made to solve the above problems, and has as its object to prevent, during film formation, a deposition material from reaching a portion that should be covered with a mask, so that a film having a predetermined pattern is formed on a glass substrate accurately.

In order to solve the above problems, according to the present invention, there is provided a substrate tray which holds a substrate and is arranged to oppose a thin film material source, comprising: a holding member which holds the substrate and is provided with an opening through which thin film material particles emitted from the thin film material source to be deposited on the substrate pass, a first mask which is arranged between the holding member and the substrate and shields the thin film material particles passing through the opening not to deposit on the substrate, to form a thin film having a predetermined shape on the substrate, and a second mask which is arranged between the holding member and the first mask and covers the first mask at least partly to shield the thin film material particles not to deposit on the first mask.

According to the substrate tray of the present invention, the second mask has the same shape as that of the first mask.

According to the substrate tray of the present invention, the second mask comprises a plurality of members.

According to the substrate tray of the present invention, the second mask is made of the same material as that of the first mask.

According to the substrate tray of the present invention, the second mask is made of a material different from that of the first mask.

A film forming apparatus according to the present invention including: a deposition chamber which accommodates a thin film material source, a substrate tray which holds a substrate, and transport means for transporting the substrate tray, the transport means placing the substrate tray at a position to oppose the thin film material source to form a thin film on the substrate, wherein the substrate tray comprises a holding member which holds the substrate and is provided with an opening through which thin film material particles emitted from the thin film material source pass, a first mask which is arranged between the holding member and the substrate and shields the thin film material particles passing through the opening not to deposit on the substrate, to form a thin film having a predetermined shape on the substrate, and a second mask which is arranged between the holding member and the first mask and covers the first mask at least partly to shield the thin film material particles not to deposit on the first mask.

According to the present invention, the second mask is arranged between the holding member and the first mask. The second mask covers the first mask at least partly to suppress film formation on the first mask. This prevents hardening and distortion of the first mask. Even if the glass substrate (substrate) is deflected by heat radiation, the adhesion strength is maintained. Also, the deposition material is prevented from reaching that portion of the glass substrate which is to be covered with the first mask. Thus, a film having a predetermined pattern can be formed on the glass substrate.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a view showing the internal arrangement of a film forming apparatus according to an embodiment of the present invention;

FIG. 2A is an exploded perspective view of a substrate tray according to the embodiment of the present invention;

FIG. 2B is a plan view when a tray, second mask, first mask, and glass substrate are overlaid in the order named as the arrangement of the substrate tray according to the embodiment of the present invention;

FIG. 3A is a sectional view showing the arrangement of the substrate tray according to the embodiment of the present invention, and shows a state after a protection film is formed on the glass substrate using the substrate tray and film forming apparatus;

FIG. 3B is a view showing a state after a protection film is formed on a glass substrate using a substrate tray according to another embodiment of the present invention;

FIG. 3C is a view showing a state after a protection film is formed on a glass substrate using a substrate tray according to still another embodiment of the present invention;

FIG. 4A is an exploded perspective view of a conventional substrate tray;

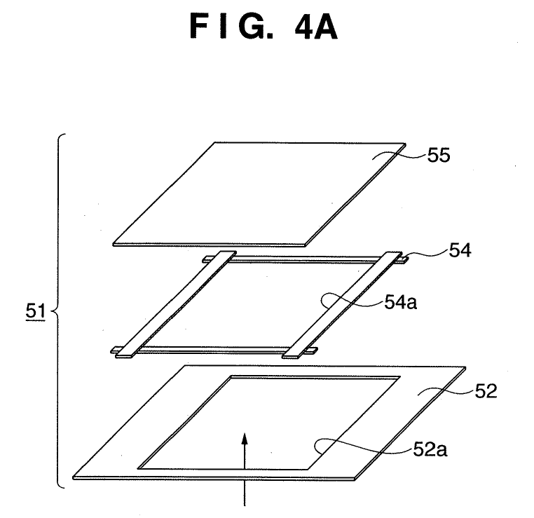

FIG. 4B is a plan view when a holding member, mask, and glass substrate are overlaid in the order named as the arrangement of the conventional substrate tray; and

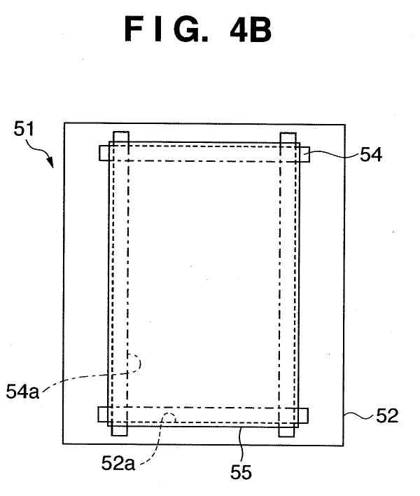

FIG. 5 is a sectional view showing the state of the mask on which a film has been formed using the conventional substrate tray, and a film formation state on the glass substrate.

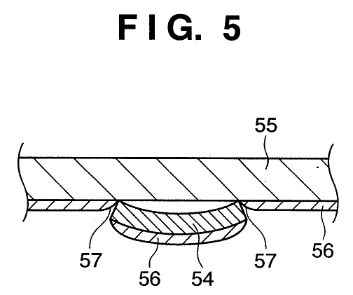

### BEST MODE FOR CARRYING OUT THE INVENTION

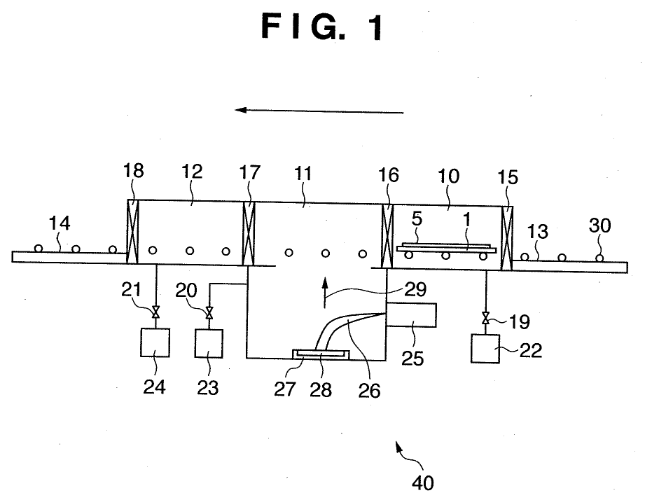

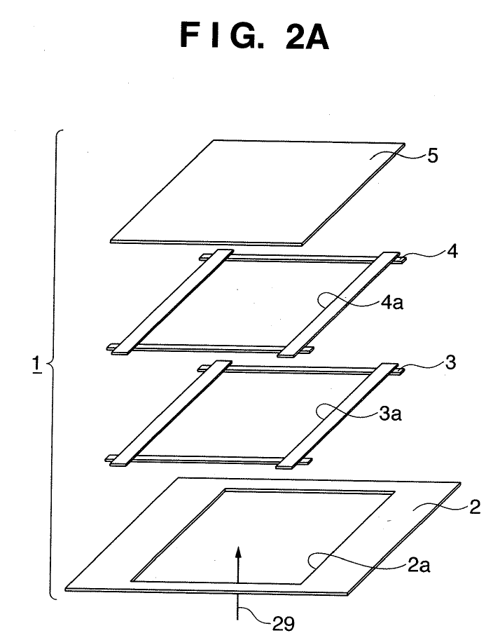

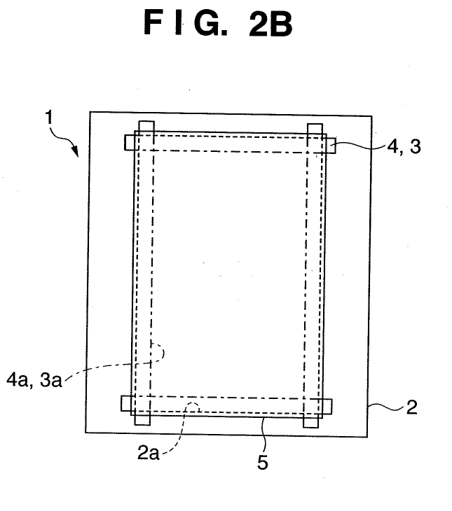

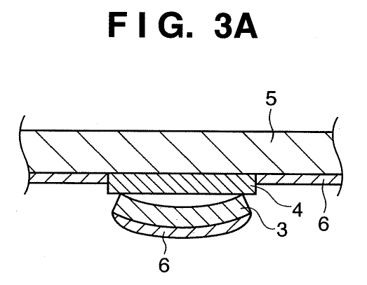

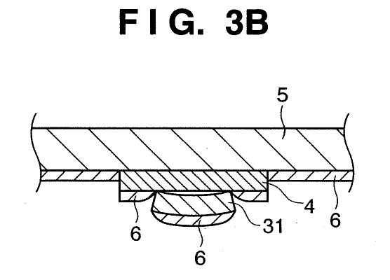

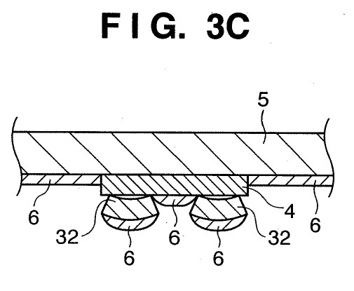

Embodiments of the present invention will be described in detail with reference to FIG. 1, FIG. 2A, FIG. 2B, FIGS. 3A and 3B, and FIG. 3C.

FIG. 1 is a view showing the internal arrangement of a film forming apparatus 40 which continuously transfers a substrate tray 1 holding a glass substrate 5 to continuously form, for example, a protection film for a PDP. In the film forming apparatus 40, a substrate tray loading chamber 10 and substrate tray unloading chamber 12 are connected to the two sides of a deposition chamber 11 through gate valves 16 and 17, respectively. The substrate tray loading chamber 10 is provided with a platform 13, where the glass substrate 5 is placed on the substrate tray 1, through a gate valve 15. The substrate tray unloading chamber 12 is provided with a platform 14, with which the glass substrate 5 is taken out from the substrate tray 1, through a gate valve 18.

Transport rollers (transport means) 30 which are generally used for transporting the tray are arranged along the track of the substrate tray 1 which communicates through the platform 13, substrate tray loading chamber 10, deposition chamber 11, substrate tray unloading chamber 12, and platform 14. The substrate tray loading chamber 10, deposition chamber 11, and substrate tray unloading chamber 12 are connected to exhaust devices 22, 23, and 24 through valves 19, 20, and 21, respectively, so that they are controlled to predetermined vacuum degrees.

In the deposition chamber 11, a ring hearth 27 which stores a deposition material source (thin film material source) (e.g., MgO) 28 is arranged under the transport rollers 30. A plasma gun 25 which irradiates the deposition material source 28 with a plasma beam 26 to heat and evaporate the deposition material source 28, thus generating deposition material particles (thin film material particles), is arranged in the deposition chamber 11. In place of the plasma gun 25, an electron gun can be employed.

FIG. 2A is an exploded perspective view showing the arrangement of the substrate tray 1 of the present invention, and FIG. 2B is a plan view when a holding member 2, second mask 3, first mask 4, and glass substrate 5 are overlaid in the order named. As shown in FIG. 2A, the substrate tray 1 according to this embodiment comprises the holding member 2 which holds the glass substrate 5, and the second mask 3 and first mask 4 which are sequentially arranged between the holding member 2 and glass substrate 5. During film formation, the substrate tray 1 is arranged above the deposition material source 28 to oppose it. The holding member 2 has an opening 2a with a predetermined shape corresponding to the shape of the glass substrate 5. The deposition material particles evaporating from the deposition material source 28 on the ring hearth 27 upon being irradiated with the plasma beam 26 and traveling toward the glass substrate 5 pass through the opening 2a. The deposition material particles scatter in the direction of an arrow 29 shown in FIG. 2A. The holding member 2 is formed of a SUS plate, a Ti plate, or the like having a thickness of, for example, approximately 3 mm to 10 mm.

The first mask 4 is formed by arranging, for example, four long plate-like members having the same shape into a lattice to form an almost rectangular opening 4a. The first mask 4 can employ any arbitrary metal material that ensures a mechanical strength required of a mask and flexibility against the substrate, and can be made of, for example, aluminum, nickel, tungsten, copper, titanium, molybdenum, tantalum, or iron, or their alloy or their oxide. The thickness of the first mask 4 is preferably 0.15 mm or less from the viewpoint of, for example, the mechanical strength and distortion resistance.

The second mask 3 is formed by arranging, for example, four long plate-like members made of the same material as and having the same shape as those of the first mask 4 into a lattice in the same manner as the first mask 4, and comprises an opening 3a having the same shape as the opening 4a of the first mask 4. The first mask 4 and second mask 3 are overlaid between the holding member 2 and glass substrate 5, with the openings 4a and 3a coinciding with each other, such that the second mask 3 is located on the holding member 2 side and the first mask 4 is located on the glass substrate 5 side. For example, screws fix the two masks 3 and 4 to the holding member 2. The masks 3 and 4 may be fixed in an integral state or separately as far as their adhesion strength is ensured. The deposition material particles 29 passing through the opening 2a of the holding member 2 pass through the openings 3a and 4a to reach the glass substrate 5. The thickness of the two masks 3 and 4 in the overlaid state is preferably 0.3 mm or less. If the first mask 4 is thinner than the second mask 3 within this thickness range, it is more preferable because the thin first mask 4 can have flexibility while the thick second mask 3 increases the light-shielding properties against heat radiation, protecting the first mask 4 more easily. Each of the two masks 3 and 4 can have any arbitrary shape as far as it can cover that portion of the glass substrate 5 which should be masked, and can have, for example, a square frame-like shape having an opening at the center of a plate-like member. When the glass substrate 5 is to be cut after film deposition to form two glass plates, masks bridged at the centers can be used.

An example of a film forming process using the substrate tray 1 and film forming apparatus 40 according to this embodiment will be described.

First, on the platform 13, the glass substrate 5 (e.g., 1.5-m square and 2.8-mm thick) is placed on the substrate tray 1 in which the first mask 4 and second mask 3 are attached. Subsequently, the gate valve 15 is opened, and the substrate tray 1 is transported on the transport rollers 30 to the substrate tray loading chamber 10. The gate valve 15 is closed, the interior of the substrate tray loading chamber 10 is evacuated to, for example, approximately 10 Pa, and a heater (not shown) heats the glass substrate 5 to a predetermined temperature. After that, the gate valve 16 is opened, and the substrate tray 1 is moved to the deposition chamber 11.

The interior of the deposition chamber 11 is evacuated to a predetermined vacuum degree, and the heater (not shown) arranged on the lower side of the substrate tray 1 heats the glass substrate 5 to a predetermined temperature. While introducing oxygen gas into the deposition chamber 11 at a predetermined flow rate, the plasma gun 25 is driven to irradiate the evaporation material source 28 in the ring hearth 27 with the plasma beam 26, thereby heating the evaporation material source 28. The evaporation material particles 29 evaporating from the deposition material source 28 pass through the opening 2a of the holding member 2, the opening 3a of the second mask 3, and the opening 4a of the first mask 4 to reach the glass substrate 5, to grow a MgO film 6 on its surface at a high rate. When the MgO film 6 having a desired thickness is formed, driving of the plasma gun 25 and introduction of the oxygen gas are stopped, thus ending deposition.

After the deposition, the substrate tray 1 is sent from the deposition chamber 11 to the substrate tray unloading chamber 12 (the gate valve 17 is kept closed) and cooled to a predetermined temperature. After that, the gate valve 18 is opened, and the substrate tray 1 is unloaded onto the platform 14. When the series of processing operation is ended, the substrate tray 1 from which the glass substrate 5 is removed is returned to the platform 13. An unprocessed glass substrate 5 is then placed on the substrate tray 1. The glass substrate 5 is transported to the substrate tray loading chamber 10 again, and a MgO film 6 is formed on the glass substrate 5 in the same manner as in the process described above.

The embodiments according to the present invention will be described in detail with reference to the drawings. FIG. 3A is a view showing a state after the MgO film (protection film) 6 is formed on the glass substrate 5 in accordance with the above process. As shown in FIG. 3A, the MgO film 6 is deposited not only on the glass substrate 5 but also on the second mask 3. Thus, the surface side of the second mask 3 loses flexibility and becomes hardened, and is distorted by the stress of the MgO film 6. In contrast to this, as the first mask 4 is overlaid on the second mask 3, the deposition material particles 29 hardly reach the first mask 4, and the MgO film 6 hardly covers the surface of the first mask 4. Since the second mask 3 can shield heat radiation from the deposition material source 28 and ring hearth 27, the first mask 4 is hardly affected by the heat radiation. Therefore, the first mask 4 is not hardened but maintains its shape and flexibility that it has before the start of film forming process, thus ensuring the adhesion strength with the glass substrate 5. This allows formation of accurate masking with the predetermined pattern.

FIG. 3B refers to a case in which, in place of the second mask 3, a second mask 31 made of long plate-like members each with a width narrower than that of a first mask 4 is used, and is a view showing a state after a MgO film 6 is formed on a glass substrate 5 in accordance with the process described above. As shown in FIG. 3B, as the second mask 31 has a narrow width, the MgO film 6 covers part of the first mask 4 as well. If, however, the MgO film 6 is formed only partly, the first mask 4 is hardly hardened as a whole. Even if the first mask 4 should be hardened partly, it does not warp because the stress of the film is partially moderated. Thus, the adhesion strength with the glass substrate 5 can be ensured sufficiently, and the MgO film 6 having the predetermined pattern can be formed on the glass substrate 5 accurately.

FIG. 3C refers to a case in which, in place of the second mask 3, two second masks 32 each with a further narrower width line up, and is a view showing a state after a MgO film 6 is formed on a glass substrate 5 in accordance with the process described above. As shown in FIG. 3C, as the second masks 32 have narrow widths, the MgO film 6 covers part of a first mask 4 as well. If, however, the MgO film 6 is formed only partly, the stress of the film on the first mask 4 is partially moderated. Even if the first mask 4 should be hardened partly, the adhesion strength with the glass substrate 5 can be ensured, and masking with a predetermined pattern can be formed on the glass substrate 5 accurately.

The shape of the second mask is not limited to those shown in FIGS. 3A, 3B, and 3C, but can have any arbitrary shape as far as it can suppress hardening and distortion of the first mask 4 even when a film should be formed on the first mask 4.

As described above, the substrate tray 1 according to this embodiment and the film forming apparatus 40 using this substrate tray 1 comprise, in addition to the holding member 2 which holds the glass substrate 5 and the first mask 4 which shields the thin film material particles not to deposit on the glass substrate (substrate) 5 so that the thin film on the glass substrate 5 has a predetermined shape (pattern), the second mask 3 which covers the first mask 4 at least partly. With this arrangement, the second mask 3 covers the first mask 4 at least partly to suppress film formation on the first mask 4. This prevents hardening and distortion of the first mask 4 and accordingly maintains the flexibility of the first mask 4. Therefore, even when the glass substrate 5 is deflected by heat radiation, the first mask 4 can conform to it in tight contact with it. The second mask 3 can also prevent the deposition material from reaching that portion of the glass substrate 5 which is covered with the first mask 4. As a result, a film having a predetermined pattern can be accurately formed on the glass substrate 5. Although these embodiments are exemplified by formation of a protection film on the glass substrate 5 by deposition, the present invention can similarly be applied to a case of film formation other than deposition using a plasma gun or the like, or a case of forming a thin film other than a protection film.

Although the present invention has been described while referring to the above embodiments, note that the present invention is not limited to the above embodiments and various improvements and changes can be made in the object of improvement or within the spirit and scope of the present invention. In the above embodiments, a substrate tray comprising the two, first and second masks has been described. Alternatively, the substrate tray can comprise a third mask which further covers the second mask entirely or partly. It suffices as far as the mask has a multilayer structure.

The present invention is not limited to the above embodiments and various changes and modifications can be made without departing from the spirit and scope thereof. Therefore, to apprise the public of the present invention, the following claims are appended.

This application is based upon and claims the benefit of priority from the prior Japanese Patent Application No. 2006-188522, filed Jul. 7, 2006, the entire contents of which are incorporated herein by reference.

1 A substrate tray which holds a substrate and is arranged opposite a thin film material source, comprising:
a holding member which holds the substrate and is provided with an opening through which thin film material particles emitted from said thin film material source to be deposited on the substrate pass,
a first mask which is arranged between said holding member and the substrate and shields the thin film material particles passing through the opening from depositing on the substrate portion that is covered by the mask, to form a thin film having a predetermined shape on the substrate, and
a second mask which is arranged between said holding member and said first mask and covers said first mask at least partly to shield the thin film material particles from depositing on said first mask.

2. The substrate tray according to claim 1, wherein said second mask has the same shape as that of said first mask.

3. The substrate tray according to claim 1 or 2, wherein said second mask comprises a plurality of members.

4. The substrate tray according to claim 1 or 2, wherein said second mask is made of the same material as that of said first mask.

5. The substrate tray according to claim 1 or 2, wherein said second mask is made of a material different from that of said first mask.

6. A film forming apparatus including:
a deposition chamber which accommodates a thin film material source,
a substrate tray which holds a substrate, and
a transport means for transporting said substrate tray, said transport means placing said substrate tray at a position opposite said thin film material source to form a thin film on the substrate,
wherein said substrate tray comprises:
a holding member which holds the substrate and is provided with an opening through which thin film material particles emitted from said thin film material source pass,
a first mask which is arranged between said holding member and the substrate and shields the thin film material particles passing through the opening from depositing on the substrate portion that is covered by the mask, to form a thin film having a predetermined shape on the substrate, and
a second mask which is arranged between said holding member and said first mask and covers said first mask at least partly to shield the thin film material particles from depositing on said first mask.

7. The substrate tray according to claim 1, wherein an area of said second mask for shielding deposition of the thin film material particles is smaller than an area of said first mask for shielding deposition of the thin film material particles.

8. The film forming according to claim 6, wherein an area of said second mask for shielding deposition of the thin film material particles is smaller than an area of said first mask for shielding deposition of the thin film material particles.

9. A film forming method comprising a step of forming a thin film on the substrate using the film forming defined in claim 6.

10. The film forming method according to claim 9, wherein the thin film includes a MgO film.

11. A display device manufacturing method comprising a step of forming a MgO film as a thin film on a substrate for manufacturing a display device using the film forming method defined in claim 9.
